(19) United States
(12) Patent Application Publication
(10) Pub. No.: US 2010/0163572 A1
(43) Pub. Date: Jul. 1, 2010

(54) Beverage Dispenser

(76) Inventor: David Downham, Hexton (GB)

Correspondence Address: WOLF GREENFIELD & SACKS, P.C., 600 ATLANTIC AVENUE, BOSTON, MA, 02210-2206, US

(21) Appl. No.: 12/225,364

(22) PCT Filed: Mar. 15, 2007
(86) PCT No.: PCT/GB2007/000912

§ 371 Date: Mar. 23, 2009

(30) Foreign Application Priority Data
Mar. 21, 2006 (GB) 0605686.5
Oct. 12, 2006 (GB) 0620291.5

(51) Int. Cl. B67D 7/00; B67D 7/78; B67D 7/06; B67D 7/80; B65D 83/00; G05D 7/00

(52) U.S. Cl. 222/1; 222/145.6; 222/148; 222/146.6; 700/283; 222/144.5; 222/129.1

(57) ABSTRACT

There is disclosed a beverage dispenser in which a cooled pre-mixed carbonated beverage, or a carbonated beverage component such as soda water, is dispensed through a delivery valve (2b-5b) into a delivery- tube (2c-5c) leading to a spigot (2d-5d) and wherein a carbonating gas is injected via a gas injection line (12a-12d) into the delivery tube immediately downstream of the delivery valve during dispensing of the carbonated beverage. The carbonating gas may be injected continuously during dispensing of the beverage, or an intermittent cyclic injection of gas may be provided. The gas and beverage flow controls may be arranged so that carbonating gas injection is commenced before dispensing of the beverage commences. In an advantageous embodiment, gas may be injected into the delivery tube after the delivery valve is closed, in order to purge any liquid remaining in the dispensing tube.

The present invention relates to beverage dispensers, and is particularly concerned with multi-flavour beverage dispensers for use in retail outlets, for dispensing drinks such as cola, carbonated water, or other carbonated soft drinks.

It has become common in bars and restaurants for soft drinks to be dispensed from a dispensing head mounted at a free end of a flexible hose, the other end of which is fixed to a structure such as a bar or counter top. The dispensing head typically dispenses a plurality of different beverages, which are supplied to the head through individual supply tubes within the flexible hose. These supply tubes are connected to reservoirs of the various beverages, which are stored in bulk at a remote location.

Conventional pre-mix systems use pressurized containers which are delivered to the premises filled with a ready-to-drink carbonated beverage. This is stored remotely from the dispense point. The beverage passes through a chiller into an insulated duct or “python” for delivery to the bar. A supplementary cooling circuit is provided within the python to keep the beverages within the python cool. An advantage of the pre-mix system is that the actual and perceived quality of the drink is close to that of the product as sold in sealed, one-serving bottles. However, a disadvantage of the pre-mix system is the expense of transporting the bulk liquid, and the logistics surrounding the return and refilling of the containers. Also, the pre-mix system has the problem that it is difficult to prevent foaming of the carbonated beverage whilst it is in transit through the python.

Conventional post-mix systems have cooling and carbonating equipment for water, and reservoirs with pumps for syrups, remote from the dispense point. The chilled carbonated water is circulated around the python keeping it and its contents cool. The syrup is pumped through the python separately from the water. The syrup and carbonated water are mixed together in the dispenser head. An advantage of the post-mix system is that it uses a concentrated syrup-typically mixed in a ratio of about 5 parts water to 1 part syrup- and mains water supply. There is thus no need to transport large volumes of water, as is the case with the pre-mix system. Disadvantages of the post-mix system are that the perceived and actual quality of the dispensed drink is poor, compared to the same product as sold in sealed, one-serving bottles. Carbonation levels in the dispensed beverage are reduced, and visually it is difficult to disguise from the customer the fact that water and syrup are mixing together, particularly when mixing occurs in the customer's glass.

The dispenser head is a complicated structure incorporating valves for supplying either premixed drinks, or for mixing carbonated water and syrups to produce drinks of differing flavours. In order to ensure that the drinks are delivered at the correct temperature, it is customary to circulate refrigerated carbonated water to the dispensing head, by providing a supply tube for the refrigerated carbonated water and a return tube extending back down the flexible hose. This circulation of the carbonated water however tends to reduce the carbonation level in the water, because of the passage of the carbonated water through the recirculation pump.

This arrangement also makes the flexible hose bulky since it has to accommodate the return tube for the recirculating carbonated water. However, if the carbonated water is not recirculated through the flexible tube, then liquid in the flexible tube will warm up during periods of non-use of the dispenser, resulting in uncooled liquid being dispensed at the start of the next dispensing operation.

A further disadvantage of the existing arrangement is that the dispenser head is a complicated structure including valves, control buttons and internal galleries. The dispenser head is also the structure most likely to be dropped or mishandled by the operator resulting in damage to the dispenser head.

The present invention has as one objective the provision of a carbonated beverage dispenser installation in which the carbonation level of the dispensed beverage is increased.

A further objective of the invention is to provide a dispensing arrangement for soft drinks in which dispensing of uncooled liquid is avoided.

A further objective of the invention is to provide a dispensing arrangement for soft drinks in which water from a mains supply may be carbonated and mixed with a concentrated flavouring syrup at the dispense premises, yet give the appearance of dispensing a pre-mixed beverage.

A further objective of the invention is to provide a dispensing arrangement for soft drinks in which still water from a mains supply is chilled and recirculated, and water from the recirculation circuit is carbonated and supplied to form a beverage or beverage component.

A further objective of the invention is to provide a dispensing arrangement for soft drinks in which a dispensing head is carried at the distal end of a flexible hose of increased flexibility, while avoiding the problem of initially dispensing uncooled liquid after a period of non-use.

Another objective of the invention is to provide a control arrangement for a beverage dispenser, which controls the dispensing of carbonated beverages so as to inject carbonating gas while the beverage is being dispensed, to increase the carbonation level in the beverage.

Another objective of the invention is to provide a control arrangement for a beverage dispenser, which controls the dispensing of beverages and the clearing of liquid from a delivery tube downstream of a dispensing valve after each dispensing operation.

According to a first aspect of the invention, there is provided a post-mix beverage dispensing system wherein carbonated water and a flavouring syrup are stored in respective containers at a storage location, respective supply ducts lead from the storage location to a flow control location, a delivery tube leads from the flow control location to a dispenser head, and respective delivery valves are provided at the flow control location to control the delivery of carbonated water and flavouring syrup to the delivery tube.

In one embodiment, carbonated water from the supply duct from one container is mixed with a syrup from a supply duct from another container at a confluence upstream of a dispensing valve, non-return valves being optionally provided in the supply ducts upstream of the confluence to prevent back flow of one liquid into the supply duct of the other.

In one embodiment, carbonated water from the container at the storage location is cooled and recirculated through an insulated sheath containing the supply ducts, to cool the liquids in the supply ducts.

In an alternative embodiment, the storage location has a plurality of containers for flavouring syrups, and the flow control location comprises a plurality of mixing valves each of which is operable to mix one of the flavouring syrups with carbonated water and supply the mixture to the delivery tube.

In one embodiment, a flexible hose houses a plurality of delivery tubes each leading from a respective delivery valve at the flow control location to a respective delivery spigot at the distal end of the flexible hose.

In one embodiment, the dispensing system includes means to purge liquid remaining in a delivery tube after each delivery operation. The purging may be effected by injecting a gas into a delivery tube after delivery of a carbonated beverage through the delivery tube. The gas may be a carbonating gas.

In one embodiment, the dispensing system includes means to inject a carbonating gas into a delivery tube during delivery of a carbonated beverage or beverage component through the delivery tube.

In a second aspect of the invention, there is provided a pre-mix beverage dispensing system wherein beverages are stored in respective containers at a storage location, respective supply ducts are provided to lead the beverages from the storage location to a flow control location, and one or more delivery tubes lead from the flow control location to a dispenser head, and respective valves are provided at the flow control location to control the delivery of the beverages to the delivery tube or tubes. At least one of the beverages may be carbonated.

In one embodiment, one of the beverages is cooled and recirculated through an insulated sheath containing the supply ducts, to cool the liquids in the supply ducts.

In one embodiment, a flexible hose houses a plurality of delivery tubes each leading from a respective valve at the flow control location to a respective delivery spigot at the distal end of the flexible hose.

In one embodiment, the pre-mix dispensing system includes means to purge liquid remaining in a delivery tube after each delivery operation. The purging may be effected by injecting a gas into a delivery tube after delivery of a carbonated beverage through the delivery tube. The gas may be a carbonating gas.

In one embodiment, the pre-mix dispensing system includes means to inject a carbonating gas into a delivery tube during delivery of a carbonated beverage through the delivery tube.

A further aspect of the invention provides an system for dispensing carbonated beverages including a carbonator for carbonating still water from a water supply and optionally one or more flavouring syrup reservoirs, respective supply ducts being provided to lead the carbonated water and syrups from the storage location to a flow control location, and a flexible hose leading from the flow control location to a dispenser head, respective delivery valves being provided at the flow control location to control the delivery of the carbonated beverages to the delivery tube, and wherein still water from the water supply is circulated through an insulated sheath containing the supply ducts, to cool the liquids in the ducts. The water supply may be the mains supply, or a reservoir for still water. Water from the recirculation circuit may be supplied to the carbonator, for carbonation and subsequent dispensing as a beverage or beverage component.

A yet a further aspect of the invention provides a carbonated beverage dispensing installation comprising:

a carbonator for carbonating still water from a water supply;

one or more reservoirs for containing flavouring syrups;

a supply duct for supplying the carbonated water from the carbonator to a delivery valve;

respective supply ducts for supplying the flavouring syrups from the reservoirs to respective delivery valves;

at least one delivery tube connecting the delivery valves to a delivery spigot; and

control means for selectively opening and closing the delivery valves;

and further comprising:

an insulated sheath containing the supply ducts;

cooling means to cool still water from the water supply;

a recirculating pump operable to circulate cooled still water from the water supply through a cooling duct within the insulated sheath; and

water supply means for supplying cooled still water from the recirculating circuit to the carbonator.

A further aspect of the invention provides a method and apparatus for dispensing a beverage, in which beverage components are selectively admitted to delivery tubes by opening and closing delivery valves at a flow control location, and wherein a purging gas is introduced into the delivery tube after closure of the delivery valve to expel liquid from the delivery tube. The delivery tube is thus maintained “dry” between dispensing operations, avoiding the problem of warm liquid being dispensed at the start of a subsequent dispensing operation, due to liquid in the delivery tube warming up to room temperature between dispensing operations.

A further aspect of the invention provides a beverage dispensing installation comprising a reservoir for a carbonated beverage, a supply duct for supplying the carbonated beverage from the reservoir to a delivery valve, a delivery tube for conducting the carbonated beverage from the delivery valve to a delivery spigot in a delivery head, and control means for selectively opening and closing the delivery valve, the installation further comprising a reservoir for a carbonating gas, a gas supply line for supplying carbonating gas from the reservoir to a gas control valve, and a gas injection line for supplying carbonating gas from the gas control valve to a gas injection port provided in the delivery tube downstream of the delivery valve, and wherein the control means is adapted to open the gas control valve to deliver carbonating gas into the delivery tube while the delivery valve delivers carbonated beverage to the delivery tube. The decrease in carbonation level caused by the sudden pressure drop across the delivery valve is mitigated by the carbonating gas injected into the delivery tube dissolving in the beverage.

In one embodiment, the beverage dispensing installation may be operated to perform carbonating gas injection while a carbonated beverage is being dispensed, and to perform a gas injection for purging liquid from the delivery tube after a beverage dispensing operation.

A further aspect of the invention provides an improved dispensing control arrangement for a beverage dispenser wherein carbonating gas injection is performed continuously or intermittently while a carbonated beverage is being dispensed.

A further aspect of the invention provides a control arrangement for a beverage dispenser operable to cause a purging gas to be introduced into the delivery tube of the beverage dispenser after each dispensing operation. The dispensing control arrangement may provide for beverages to be dispensed on a “free-flow” or on a “portion control” basis.

A further aspect of the invention provides a gas injection arrangement wherein a carbonating or purging gas injection line extends along the lumen of a beverage delivery tube, the gas injection line having gas injection openings spaced along its length.

Embodiments of the invention will now be described in detail with reference to the accompanying drawings, in which:

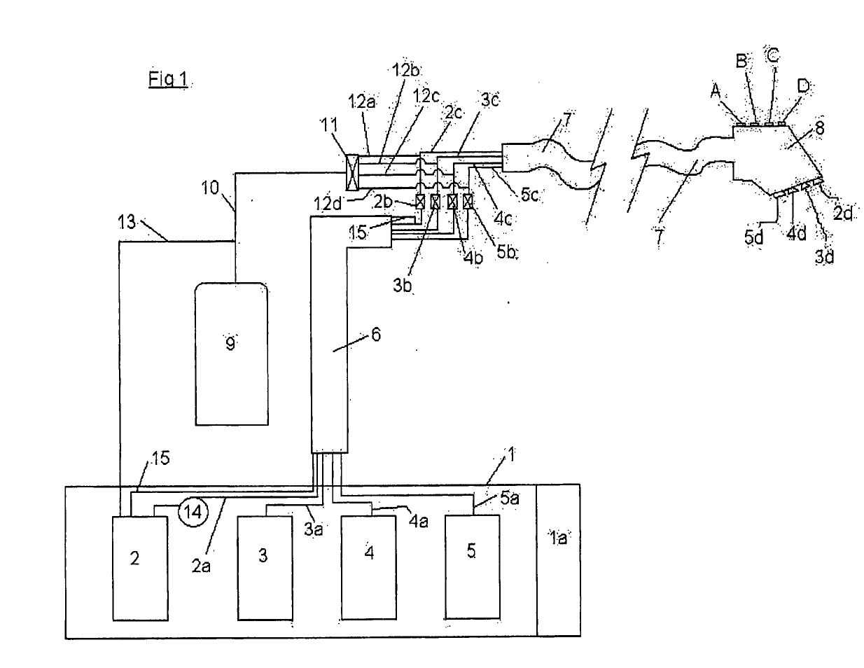

FIG. 1 is a schematic view of a beverage dispensing arrangement according to a first embodiment of the present invention;

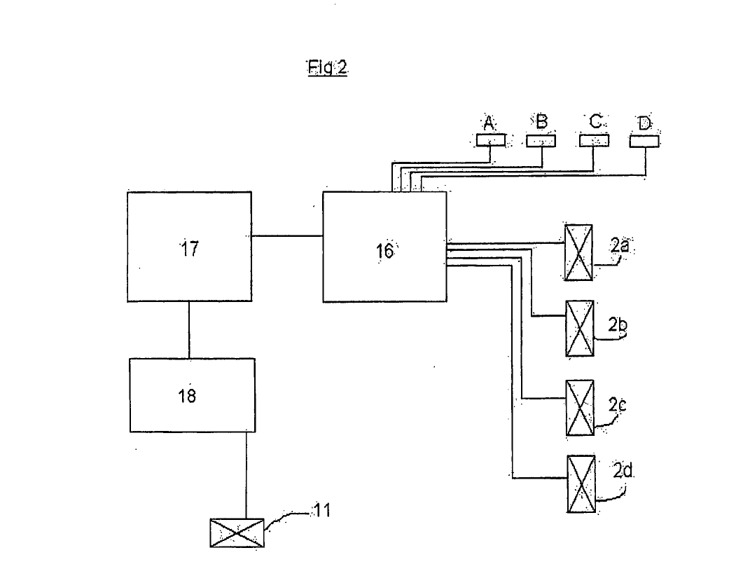

FIG. 2 schematically shows the control circuitry of the dispenser of FIG. 1.

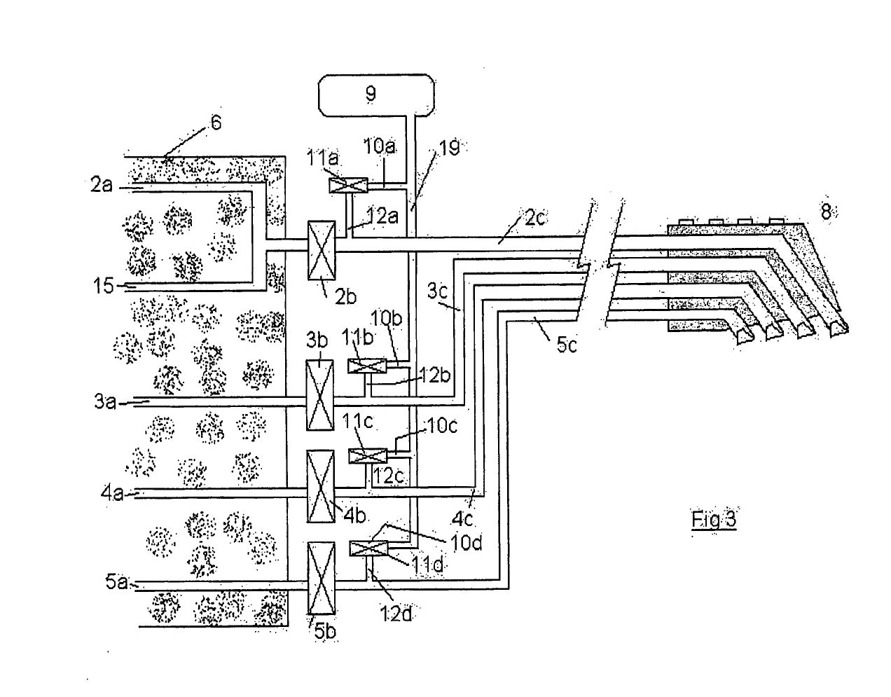

FIG. 3 is a schematic diagram showing the layout of valves and tubes in an alternative arrangement of a pre-mix dispenser;

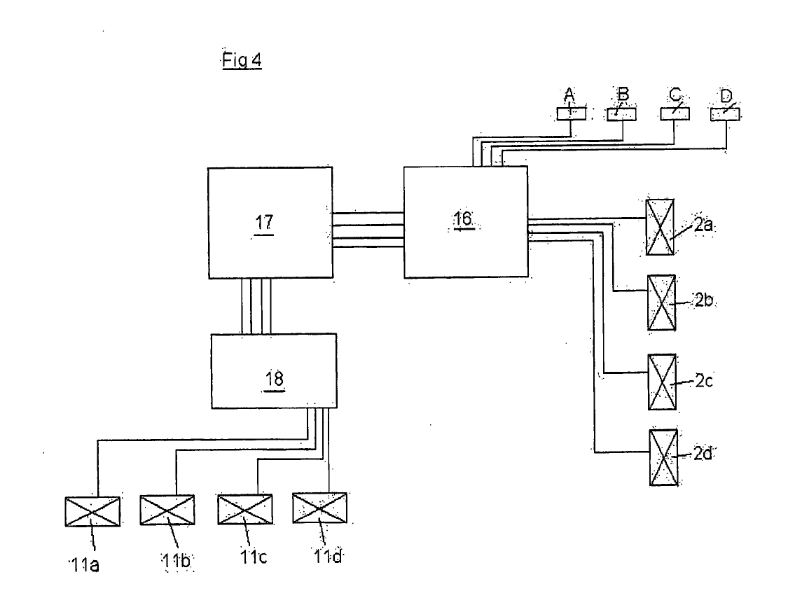

FIG. 4 illustrates schematically shows the control circuitry of the dispenser of FIG. 3;

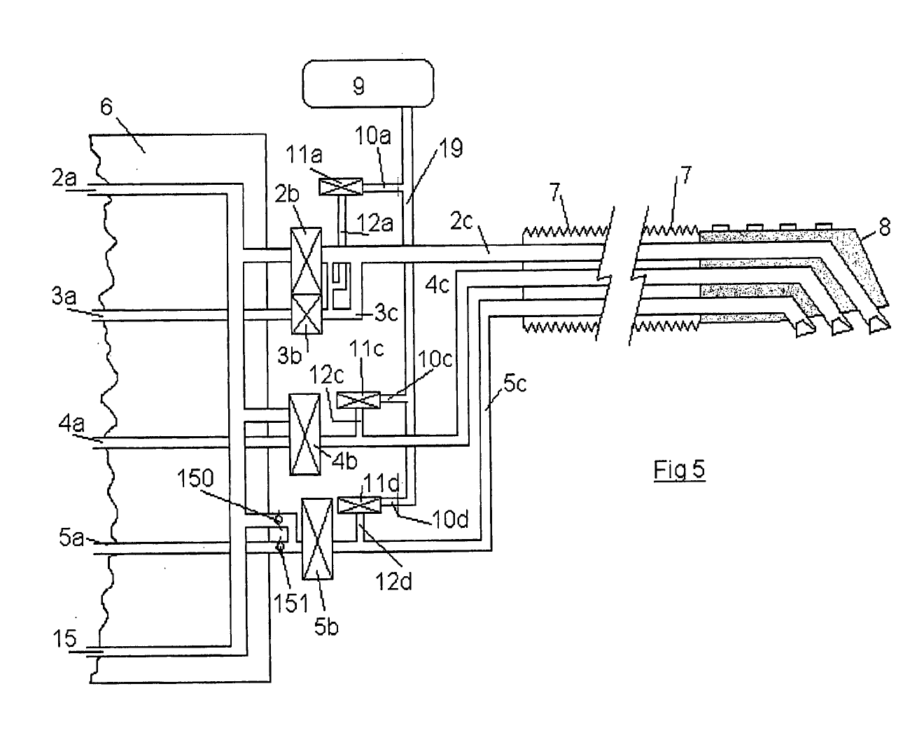

FIG. 5 illustrates a further alternative arrangement for a post-mix dispenser, showing alternative delivery valve arrangements;

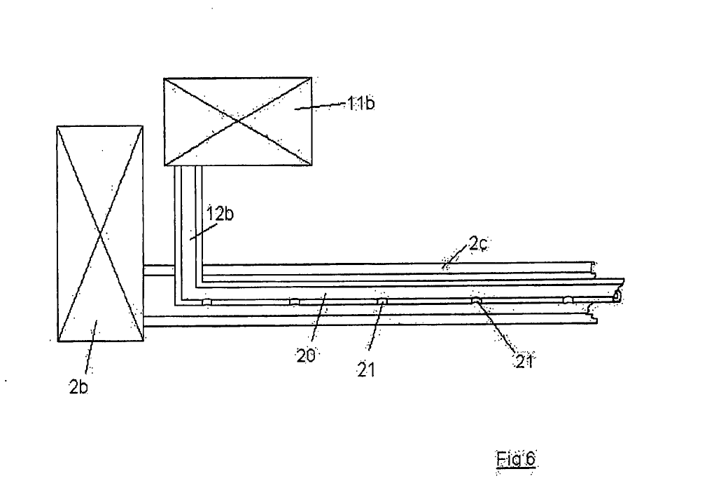

FIG. 6 is a schematic sectional view, to an enlarged scale, showing the structure of the gas injection line;

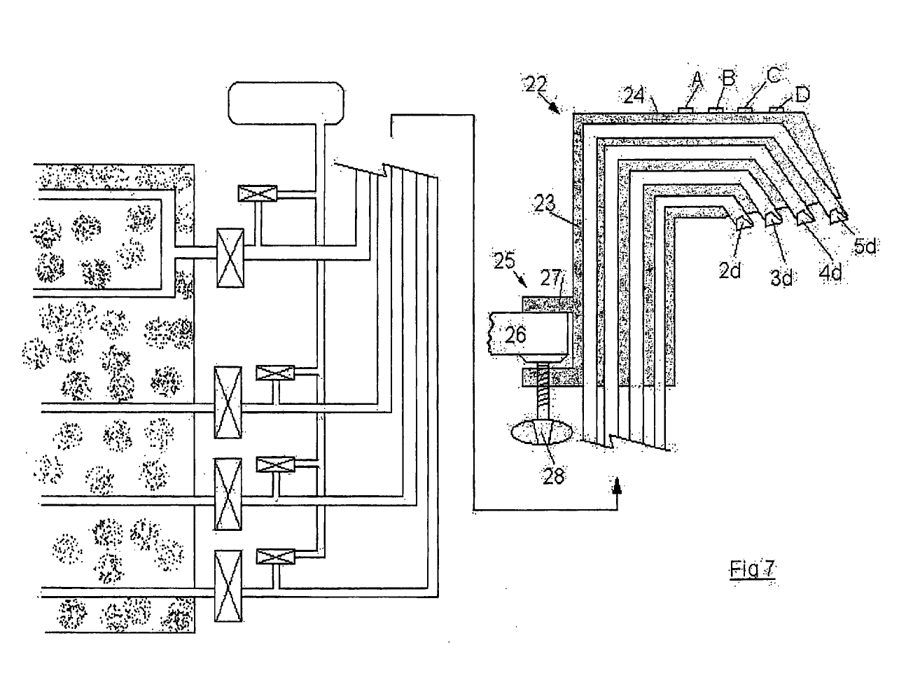

FIG. 7 illustrates a further alternative arrangement for a post-mix dispenser, as a fixed installation rather than a hand-held dispenser; and

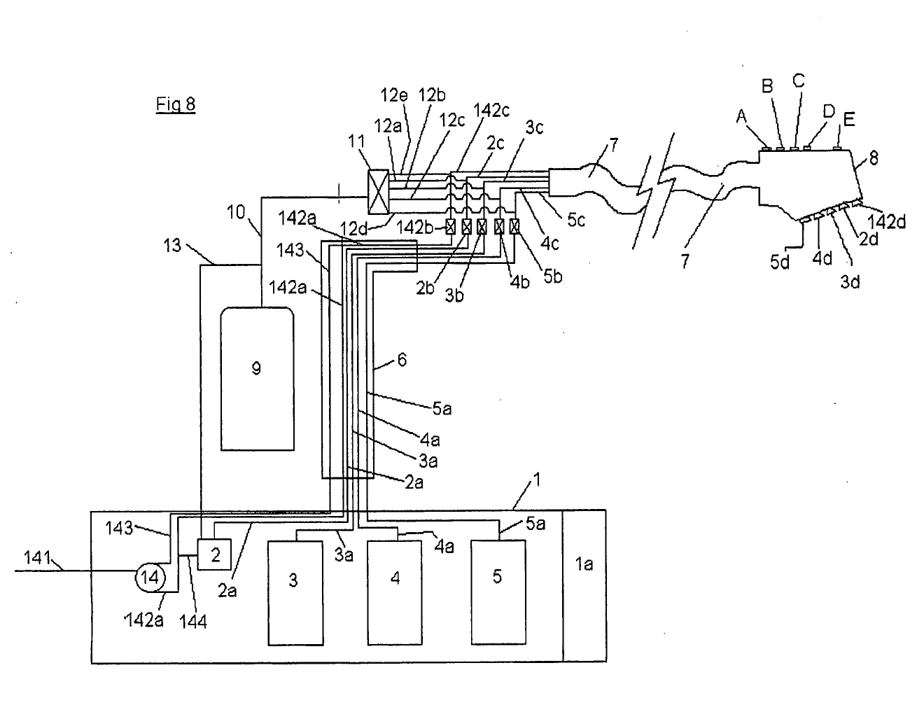

FIG. 8 is a schematic view of a beverage dispensing arrangement according to a further alternative embodiment of the present invention.

Referring now to the Figures, FIG. 1 is a schematic view of a beverage dispensing arrangement in which a refrigerated enclosure 1 houses four reservoir tanks 2, 3, 4 and 5. The reservoir tanks have respective supply ducts 2a, 3a, 4a, 5a which are lead through an insulated flexible sheath 6 to respective delivery valves to 2b, 3b, 4b and 5b. From the delivery valves, delivery tubes 2c, 3c, 4c and 5c lead through a flexible hose 7 to a delivery head 8. The delivery head 8 includes four control buttons 9a, 9b, 9c and 9d, whose purpose will be described later. At the end of each of the delivery tubes 2c, 3c, 4c and 5c is a delivery spigot 2d, 3d, 4d and 5d, incorporating a non-return valve which is resiliently biased towards a closed position, but will open when pressure in the respective delivery tube 2c, 3c, 4c or 5c increases beyond a predetermined limit. The resiliently biased valve in the delivery spigot provides a slight back-pressure to its delivery valve which improves its operation, and the small pressure drop across the spigot reduces foaming in the dispensed beverage.

A high-pressure gas reservoir 9 supplies gas through a gas supply line 10 to a gas control valve 11. When the gas control valve 11 is opened, high pressure gas is supplied through respective gas injection lines 12a, 12b, 12c and 12d to the delivery tubes 2a, 2b, 2c and 2d, at points immediately downstream of their respective delivery valves 2b, 3b, 4b and 5b. In the illustrated embodiment, the gas reservoir 9 contains carbon dioxide at high pressure, and through a carbonation supply line 13 also provides carbonating gas to the reservoir tank 2, in which is contained carbonated water.

In the illustrated embodiment of FIG. 1, refrigerated carbonated water is drawn from reservoir tank 2 by a recirculation pump 14, and is pumped through the supply duct 2a, which passes through the insulated sheath 6. At the distal end of the insulated sheath 6, a carbonated water recirculation line 15 is branched off the supply duct 2a, and returns the carbonated water through the sheath 6 to the reservoir tank 2 when the delivery valve 2b is closed. This recirculation of cooled carbonated water within the insulated sheath 6 ensures that the liquids within the supply ducts 3a, 4a and 5a remain cool.

In the embodiment illustrated in FIG. 1, the delivery valves 2a to 5a and the gas control valve 11 are electrically controlled, on the basis of signal inputs from the respective control buttons A to D on the delivery head 8.

FIG. 2 illustrates the control circuitry of the beverage dispensing installation of FIG. 1. The control circuitry comprises a delivery valve control 16, which detects an input from one of the control buttons A to D, and opens one or more of the delivery valves 2b to 5b associated with that control button, maintaining the delivery valve or valves open as long as the control button is held depressed. When the control button A to D is released, the delivery valve control circuit 16 closes the associated delivery valve or valves 2b to 5b, and sends a signal to a gas control circuit 17. The gas control circuit 17, on receiving the signal, initiates a timer circuit 18 which opens the gas control valve 11 for a predetermined time interval. At the end of the predetermined interval, gas control valve 11 is again closed.

In operation, the reservoir tank 2 is filled with carbonated water, and reservoir tanks 3, 4 and 5 are respectively filled with flavouring syrups. For example, tank 3 may be filled with a sugar-free cola syrup, tank 4 may be filled with a fruit syrup, and tank 5 may be filled with a conventional cola syrup containing sugar. Control buttons A to D on the delivery head 8 are preferably marked to indicate the beverage which will be dispensed on pressing each respective button.

While the embodiment of FIG. 1 comprises four reservoir tanks, one for carbonated water and three for non-carbonated beverage syrups, it will be understood that an installation only to supply one carbonated beverage, such as carbonated water or a single flavoured beverage, may be foreseen, in which only a single reservoir, supply duct 2a with recirculating cooling line 15, delivery valve 2b, delivery tube 2c and delivery spigot 2d is provided.

If button A is to dispense refrigerated carbonated water, then the delivery valve control circuit 16 will open delivery valve 2b when button A is pressed, and carbonated water will be delivered through valve 2b to the delivery tube 2c, and out of the delivery spigot 2d into a cup or glass held or positioned by the user. The pressure of the carbonated water is arranged to exceed the pressure required to open the non-return valve in delivery spigot 2d. When button A is released, delivery valve 2b is closed and as the pressure in delivery tube 2c falls, the non return valve in the, delivery spigot 2d also closes, trapping the liquid in the delivery tube. In order to eliminate the liquid from the delivery tube 2c, the gas control circuit 17 then actuates the timer 18 to open the gas control valve 11 for a limited period, to inject pressurised gas into the delivery tubes 2c to 5c. The high-pressure gas drives the remaining liquid from the delivery tube 2c, opening the non return valve in the delivery spigot 2d and dispensing the liquid while it is still at the cooled temperature. At the same time, high pressure gas purges the delivery tubes 3c to 5c, the gas being vented through their respective delivery spigots. The user waits until liquid has ceased to flow out of the delivery spigot, and then serves the beverage to the customer.

If the user wishes to dispense a sugar-free cola drink, then the control button B is pressed. The delivery valve control circuit 16 then opens the delivery valve 2b and the delivery valve 3b so that cooled carbonated water is delivered from the spigot 2d and sugar-free cola syrup is delivered from the spigot 3d, to mix in the cup or glass after delivery. The delivery valves 2b to 5b include flow regulating arrangements such as orifices or restrictions, to ensure that the carbonated water and the respective flavouring are delivered together in appropriate proportions. When the control button B is released, the delivery valve control circuit 16 closes the delivery valves 2b and 3b, and signals the gas control circuit 17 to activate the controller 18 and open the gas control valve 11 for a predetermined period. The injection of high-pressure gas into the delivery tubes causes any liquid remaining in the delivery tubes to be delivered through their respective delivery spigots, as described before.

In the manner similar to the operation controlled by the control button B, buttons C and D respectively cause the opening of delivery valve combinations 2b and 4b, and 2b and 5b, resulting in the simultaneous delivery of carbonated water and the appropriate flavouring.

As will be evident, the liquid dispensed by the dispenser head is drawn from liquid stored in the supply ducts 2a to 5a, which are contained within the insulated sheath 6 (this sheath being commonly referred to as a “python”). This liquid is maintained at the cooled temperature by the recirculation of carbonated water through the supply duct 2a and the recirculation line 15, driven by the recirculation pump 14. The reservoir tanks 3, 4 and 5 containing the flavouring syrups may be pressurised in order to deliver the syrup through the supply ducts when the respective delivery valves are opened, or may be provided with pumps or other delivery means to ensure that syrup is delivered at the required rate when the respective delivery valve is opened.

Since no liquid remains in the delivery tubes, which are outside the insulated sheath or python after each dispensing operation, due to the purging of the delivery tubes by the pressurised gas, the liquid or liquids dispensed in each dispensing operation are drawn directly from the supply ducts 2a to 5a within the python, and are therefore cool. Furthermore, since cooling of the liquids in the python is achieved by a recirculating the carbonated water, there is no need for an additional refrigerant cooling circuit to be present in the python, reducing installation cost and space requirements.

FIG. 3 illustrates an alternative arrangement for the delivery of purging gas to the delivery tubes 2c to 5c. In contrast to the arrangement shown in FIG. 1, where a single gas control valve 11 delivers purging gas to all of the delivery tubes 2c to 5c simultaneously, in the arrangement of FIG. 3 purging gas is delivered from a gas reservoir 9 to a gas manifold 19. The manifold 19 is connected via individual gas supply lines 10a, 10b, 10c, 10d to respective gas control valves 11a, 11b, 11c and 11d. Each of the gas control valves is then connected to a respective one of the delivery tubes 2c to 5c, immediately downstream of its respective delivery valve 2b to 5b, via a respective gas injection line 12a to 12d. The delivery head 8 is the same as has been described in relation to FIG. 1.

FIG. 4 illustrates schematically the control circuitry for the dispenser of FIG. 3. The delivery valve control circuit 16 operates in a similar manner to that described in relation to the embodiment of FIGS. 1 and 2, in that when one of the control buttons A to D is pressed, the delivery valve control circuit 16 opens the delivery valve 2b to dispense carbonated water, and optionally also one of the delivery valves 3b, 4b and 5b to dispense a flavouring syrup to be mixed with the carbonated water. While the control button is pressed, the valves are opened to deliver a flow of liquid from the delivery head 8. When the button is released, the delivery valve control circuit sends a signal to the gas control circuit 17. The signal indicates which of the delivery valves 2b to 5b has been opened, and the gas control circuit 17 then sends a signal to the timer circuit 18 instructing the opening of one or more of the respective gas control valves 11a to 11d, so that pressurised gas is injected only into those delivery tubes 2c to 5c which have just been used to dispense liquid, in order to purge the liquid from those delivery tubes via their delivery spigots 2d to 5d. When the gas control valves 11a to 11d are open, pressurised gas is delivered from the gas reservoir 9 via the gas manifold 19 to the gas supply lines 10a to 10d, and then through the open gas control valve 11a to 11d to the gas injection line 12a to 12d for injection into the delivery tubes 2c to 5c. The arrangement shown in FIGS. 3 and 4 is more economical in its use of pressurised gas, since the gas is supplied only to delivery tubes which have been used, in contrast to the arrangement in FIG. 1 where all of the delivery tubes are purged each time any of them is used.

FIG. 5 shows a further alternative arrangement of the beverage dispenser. In this arrangement, the insulated sheath or python 6 contains as before a supply duct 2a and a recirculation line 15 for carbonated water, and supply ducts 3a, 4a and 5a for flavour syrups. The supply duct 2a for carbonated water is led to a delivery valve 2b, and then to a delivery tube 2c leading to the delivery head 8. The supply duct 3a is led to a delivery valve 3b, and the delivery tube 3c from the delivery valve 3b is then joined to the delivery tube 2c. The delivery tube 2c will therefore delivery either pure carbonated water, if delivery valve 2b is opened alone, or it will deliver a mixture of carbonated water and flavour syrup if valves 2b and 3b are opened simultaneously.

Supply duct 4a is led to a combined mixing and delivery valve 4b, which is also supplied with carbonated water from the supply duct 2a. When the valve 4b is opened, a mixture of carbonated water and flavoured syrup is delivered to the delivery tube 4c and thence to the delivery head 8.

In an alternative arrangement, illustrated in FIG. 5, supply duct 5a is led through a non-return valve 151 to a delivery valve 5b, and the supply duct 2a is led, through a non-return valve 150 to join the supply duct 5a upstream of the delivery valve 5b. Opening the valve 5b delivers a mixture of flavoured syrup and carbonated water to the delivery tube 5c, while the non-return valves 150 and 151 prevent syrup from flowing into the carbonated water supply duct 2a if the syrup pressure is higher than the water pressure, and vice versa. Preferably, the delivery valves 2b to 4b include metering means such as adjustable orifices to control the flow rates of the carbonated water and syrup to ensure the correct mixture ratio is delivered to the delivery tubes 2c to 5c. Non-return valves 150 and 151 may serve as flow control orifices to regulate the proportions of the syrup and water mixture delivered to the delivery tube 5c, or separate flow control orifices (not shown) may be provided.

The delivery valve arrangements shown in FIG. 5 in relation to either of valves 4b and 5b may be adopted for all or some of the delivery valves at a flow control location.

In the arrangement of FIG. 5, high pressure gas from a gas reservoir 9 is supplied to a gas manifold 19, and from the manifold 19 via gas supply lines 10a, 10c and 10d to respective gas control valves 11a, 11c and 11d. Gas control valve 11a delivers gas via a gas injection line 12a to the delivery tubes 2c and 3c immediately downstream of their respective valves 2b and 3b. Gas control valves 11c and 11d respectively deliver gas through gas injection lines 12c and 12d to the delivery tubes 4c and 5c immediately downstream of the mixing and delivery valves 4b and 5b, respectively.

The arrangement shown in FIG. 5 allows the flexible hose 7 which surrounds the delivery tubes 2c, 4c and 5c to be reduced in thickness and thus increased in flexibility, since the flexible hose 7 has only to accommodate three delivery tubes rather than, four as in the previous embodiment.

The control circuitry for the embodiment illustrated in FIG. 5 is similar to that illustrated in FIG. 4, except that the gas control valve 11b shown in FIG. 4 is omitted. The delivery valve control circuit 16 is arranged so that when control button A is pressed, the delivery valve 2b is opened and pure carbonated water is delivered through delivery tube 2c. When control button B is pressed, delivery valves 2b and 3b are opened simultaneously, and a mixture of carbonated water and flavoured syrup is delivered through delivery tube 2c.

As before, when the control button A or B is released, the delivery valve control circuit 16 signals the gas control circuit 17, which initiates the timer circuit 18 to supply gas through the gas control valve 11a, to purge any liquid from the delivery tube 2c.

In an alternative embodiment, the delivery valves 2b and 3b, and the combined delivery and mixing valves 4b and 5b, may all be connected to a single delivery tube which extends through the flexible hose 7 to a single delivery spigot. A single gas control valve and gas injection line will be provided, to inject gas into the delivery tube downstream of the valves 2b to 5b. Since after each delivery operation the delivery tube is purged of remaining liquid by the gas purging operation, the beverage dispensed at each operation will not contain any residue of the previously dispensed beverage.

In the installations illustrated in FIGS. 1, 3 and 5, the gas injection lines 12a to 12d are shown as being simply joined to the beverage dispensing lines 2c to 5c at a “T” joint, to deliver the purging gas to the beverage dispensing lines immediately downstream of the respective delivery valves 2b to 5b, but other configurations are possible, for example with the gas injection line joining the delivery tube at an acute angle to inject gas in an axial direction away from the delivery valve.

FIG. 6 illustrates a preferred embodiment of the gas injection line 12. In the Figure, delivery valve 2b and delivery tube 2c are shown, with gas control valve 11b and gas injection line 12b. The gas injection line 12b extends from the gas control valve 11b, through the wall of the delivery tube 2c, and then a portion 20 of the gas injection line extends along the delivery tube 2c within the lumen of the delivery tube. The portion 20 of the gas injection line has openings 21 spaced along its length, to deliver gas from within the portion 20 to the lumen of the delivery tube 2c. Preferably, the portion 20 of the gas injection line extends for a substantial distance along the delivery tube. In a typical installation, the portion 20 may be up to one metre in length, with the openings 21 spaced at intervals of approximately 100 mm. In an typical installation, the delivery tube 2c has an internal diameter of approximately 5 mm, and the gas injection line 12b has an external diameter of approximately 3 mm. By extending the gas injection line 12b along the length of the delivery tube 2c, internal wetting of the delivery tube by the delivered liquid is reduced, and a more complete purging of the liquid from the delivery tube is ensured.

While the embodiments so far described have been installations in which the delivery head is mounted to a flexible hose 7, an alternative arrangement illustrated in FIG. 7 includes a fixed dispensing stand instead of the hose 7 and delivery head 8. In the embodiment shown in FIG. 7, the pipework and flow control up to and including the delivery valves 2b to 5b and the gas control valves 11a to 11d are as illustrated in relation to the embodiment of FIG. 3, and control is effected in the same way as has been described in relation to FIG. 4. The delivery tubes 2c to 5c are led not to a delivery head 8 as shown in FIG. 3, but to a delivery stand 22 comprising an upstanding pillar 23, a top surface 24 including control buttons A to D, and delivery spigots 2d to 5d including non-return valves as previously described. At the base of the pillar 23 a clamping arrangement 25 is provided for fixing the pillar to an edge of a countertop 26, by clamping the countertop against an abutment 27 using a clamping screw 28.

In the fixed arrangement shown in FIG. 7, a drip tray may be provided to catch any drips from the delivery spigots 2d to 5d.

The control arrangements for the “fixed” embodiment of FIG. 7 may differ slightly from those of the previous embodiments, in that the gas control circuit 17 may be arranged to purge the delivery tubes 2c to 5c at predetermined intervals, in order to ensure that no liquid is present downstream of the delivery valves 2b to 5b. Also, in the “fixed” embodiment, the control buttons A to D need not be placed on top of the pillar 23, but may be positioned on or adjacent to the base of the pillar, or in a separate control panel.

While in the described embodiments carbon dioxide is used as the purging gas, it is contemplated that other inert gases such as nitrogen may be used, or compressed air may be used as a purging gas. In alternative embodiments, pipe cleaning fluids may be injected into the delivery tubes 2c to 5c using the gas supply lines 10, gas control valves 11 and gas injection lines 12, provided that the gas control valves 11 are suitably constructed to handle both liquids and gases. In the embodiment illustrated in FIG. 7, automatic cleaning of the delivery tubes may be provided for, using the gas control circuitry and additional cleaning fluid supply means to intermittently inject cleaning fluid through the gas injection lines, and thereafter purge the delivery tubes with pressurised gas. Such a control arrangement may, for example, be automated and controlled by a clock circuit so that the delivery tubes are cleaned automatically after a period of use of the dispenser arrangement, such as after closing time of the establishment in which the beverage dispenser is installed. A provision for manual cleaning may be made, providing an input means such as a control button to initiate a cleaning sequence in which cleaning fluid is injected into the delivery tubes to fill them, and after a predetermined period pressurised gas is injected into the delivery tubes to expel the cleaning fluid.

In the embodiments described above, control of the dispensing of beverages has been on a “free-flow” basis, in that beverage is dispensed for as long as the control button is held depressed. It is also foreseen that the delivery valve control circuit 16 may be arranged to provide portion control, for example by arranging the delivery valve control circuit 16 so that when a one of the control buttons is depressed for a short time, or “tapped”, then a predetermined amount of beverage is dispensed. This may be achieved by causing the delivery valve control circuit 16 to open the relevant delivery valves for a predetermined time, in response to a “tap” of the control button. The control circuitry may be operable in a “dispense” mode for normal operation, and in a “teaching” mode, for setting the amount of beverage to be dispensed as a portion. The control circuitry may select the “teaching” mode or the “dispense” mode in response to a control signal from a selector input, or from a predetermined combination of control buttons being pressed together.

In the teaching mode, the control button may be held depressed until the required amount of beverage has been dispensed, and the control button is then released. The delivery valve control circuitry will memorise the time for which the button was held depressed. When the control circuitry is again in the “dispense” mode, a “tap” on the control button will cause the delivery valve control circuit to open the delivery valve for the memorised time interval.

In addition to the control buttons A to D, the dispenser head may be provided with two or more further buttons M and L indicative of different portion sizes. The control circuitry may, for example, be arranged so that when control button A is pressed on its own, a “small” portion is dispensed. When the control button A is pressed in combination with the M button, a “medium” portion may be dispensed, and when the control button A is pressed in combination with the L button a “large” portion may be dispensed.

The reservoirs for flavouring syrups described in the above embodiments are maintained refrigerated in the cooled enclosure 1. It is however foreseen that the flavouring syrups may be stored at room temperature, and may pass through a chilling unit before entering the delivery tube and the python.

In a further alternative mode of operating the beverage dispenser, it is foreseen that carbonating gas (CO₂) may be injected into the delivery tube for the carbonated liquid via its respective gas injection line during the dispensing of a beverage, in order to maintain a higher level of carbonation in the liquid than is the case when liquid is simply dispensed from the beverage dispenser without additional gas injection.

This alternative mode of operation may be used with the arrangement illustrated in FIG. 3, in which CO₂ (used as a purging gas) is delivered from a gas reservoir 9 to a gas manifold 19 connected via individual gas supply lines 10a, 10b, 10c, 10d to respective gas control valves 11a, 11b, 11c and 11d. Each of the gas control valves is connected to one of the delivery tubes 2c to 5c, immediately downstream of its respective delivery valve 2b to 5b via a respective gas injection line 12a to 12d. The delivery head 8 is the same as has been described in relation to FIG. 1.

The control circuitry for the dispenser operates in a similar manner to that described in relation to the embodiment of FIGS. 1 and 2, in that when one of the control buttons A to D is pressed, the delivery valve control circuit 16 opens the delivery valve 2b to dispense carbonated water, and optionally also one of the delivery valves 3b, 4b and 5b to dispense a flavouring syrup to be mixed with the carbonated water. While the control button is pressed, the valves are opened to deliver a flow of liquid from the delivery head 8. In this embodiment, however, the delivery valve control circuit 16 also sends a signal to the gas control circuit 17 to open the appropriate gas control valve 11a to inject carbonating gas (CO₂) into the carbonated liquid being dispensed.

The gas injection may be started immediately liquid flow is established by opening the delivery valve 2b, and may continue as a continuous injection of gas during delivery of the liquid. Alternatively, gas injection may be made intermittently while the liquid flows. In the case of an intermittent delivery of gas, gas may be injected for a first predetermined interval and then the gas supply turned off for a second interval, and then this cycle may be repeated. The first and second intervals may be of equal length.

In a yet further embodiment, the delivery valve control circuit 16 and the gas control circuit 17 may be arranged so that when one of the buttons A to D is pressed, gas is first injected into the appropriate delivery tube to pressurise the tube, prior to opening the delivery valve 2b to dispense carbonated water. Gas injection may then continue, either continuously or intermittently, during dispensing of the carbonated liquid.

When the button is released, the delivery valve control circuit operates to close the delivery valve 2b and any of the delivery valves 3b, 4b and 5b which have been open. The delivery valve control circuit 16 may then send a signal as before to the gas control circuit 17 to indicate that liquid dispensing has ceased. The gas control circuit 17 then sends a signal to the timer circuit 18 so that the respective gas control valve 11a to 11d continues to admit gas to the delivery tube or tubes 2c to 5c which have just been used to dispense liquid, in order to purge the liquid from the delivery tubes via their respective delivery spigots 2d to 5d.

The pressure at which gas is injected into the delivery tube during dispensing of carbonated liquid is arranged to be slightly higher than the dynamic pressure of the liquid flowing past the point of gas injection. Typically, if the dynamic pressure of the liquid at the injection point is 20 psi (1.378 bar), then the gas is injected at a pressure of from 20 up to 25 psi (1.378 to 1.722 bar). If purging of the delivery tube is performed after the liquid delivery has ceased, the gas injection pressure may be varied after the end of the liquid delivery, either to purge the delivery tube using gas at a pressure higher or lower than the pressure used during liquid delivery for injecting the gas. Gas purging of the delivery tube may also be performed using gas at the same pressure as is used during liquid delivery for injecting the gas.

FIG. 8 shows a further alternative arrangement of the dispenser installation, the installation being similar to that of FIG. 1 and with corresponding components given the same reference numbers as in FIG. 1.

In the arrangement of FIG. 8, water is supplied from the mains via an inlet pipe 141, and is cooled in the refrigerated enclosure 1 and fed to a pump 14. From the pump 14, the water is led to a supply duct 142, which extends through the python 6 to a delivery valve 142b. A delivery tube 142c leads from the delivery valve 142b through the flexible hose 7 to a delivery spigot 142d in the dispenser head 8. An additional control button E is provided on the dispenser head 8, and an additional gas injection lines 12e is provided between the gas control valve 11 and the delivery tube 142c.

A recirculating line 143 leads from a point on the supply duct 142a at the upper end of the python 6 back to the pump 14, so that chilled still water is circulated from the pump 14 up through the python in supply duct 142a, and back down the python in recirculating line 143.

A supply branch 144 leads from the supply duct 142a to supply still water to the carbonator 2, where carbonated water is produced as required and supplied to the supply duct 2a.

The operation of this dispenser is as described in relation to the installation of FIG. 1, save that if still water is to be dispensed then control button E is pressed by the operator, which opens the delivery valve 142b to deliver chilled still water to the delivery head 8 and out of the delivery spigot 142d. As before, at the end of the delivery operation, the delivery valve 142b closes, and gas control valve 11 opens to admit purging gas to the gas injection line 12e to clear any water remaining in the delivery tube 142c by expelling it through the delivery spigot 142d.

In the arrangement shown in FIG. 8, the recirculating still water within the python 6 maintains the liquids in the supply ducts 2a to 5a cool. Since the recirculating liquid is not carbonated, the problem of loss of carbonation caused by recirculating a carbonated liquid through pump 14 does not arise, and consumption of carbonating gas is further reduced.

It will be apparent to the skilled man that any of the installations described herein may be modified to provide for the supply of still water to a recirculation circuit in the python 6 to maintain cooling, with carbonated water for dispensing being produced as required by drawing water from the chilled still water in the recirculation circuit and carbonating it. The carbonated water and/or flavouring syrups are delivered through the python 6 in their respective supply ducts.

Although gas injection during liquid dispensing is described above in relation to the apparatus shown in FIG. 3, it is to be understood that the beverage dispenser illustrated in FIGS. 1, 5, 7 or 8 may also be modified to provide gas injection into the carbonated liquid during the dispensing of a beverage.

1. A beverage dispensing system wherein respective containers for storing carbonated water and a flavouring syrup are provided at a storage location, respective supply ducts are provided to lead the carbonated water and flavouring syrup from the storage location to a flow control location, and at least one delivery tube is provided to lead the carbonated water and the flavouring syrup from the flow control location to a dispenser head, one or more delivery valves being provided at the flow control location to control the delivery of carbonated water and flavouring syrup to the or a delivery tube.

2. A beverage dispensing system according to claim 1, wherein the storage location includes a plurality of containers for flavouring syrups, and wherein the flow control location comprises a plurality of valves each of which is operable to control the delivery of carbonated water or a flavouring syrup to a delivery tube.

3. A beverage dispensing system according to claim 1, wherein the flow control location comprises a delivery valve operable to mix the flavouring syrup with carbonated water and to supply the mixture to a delivery tube.

4. A beverage dispensing system according to claim 1, wherein the a supply duct for carbonated water and a supply duct for a flavour syrup are joined upstream of a delivery valve, to mix the flavouring syrup with carbonated water and to supply the mixture to the delivery valve.

5. A beverage dispensing system according to claim 3 or claim 4, wherein the storage location includes a plurality of containers for flavouring syrups, and wherein the flow control location comprises a plurality of delivery valves each of which is operable to supply a mixture of one of the flavouring syrups with carbonated water to a delivery tube.

6. A beverage dispensing system wherein respective containers for storing carbonated beverages are provided at a storage location, respective supply ducts are provided to lead the carbonated beverages from the storage location to a flow control location, respective delivery tubes are provided to lead the carbonated beverages from the flow control location to a dispenser head, and respective valves are provided at the flow control location to control the delivery of the carbonated beverages to the respective delivery tubes.

7. A beverage dispensing system according to any preceding claim, wherein the dispensing system includes means to purge liquid remaining in a delivery tube after each delivery operation.

8. A beverage dispensing system according to claim 7, wherein the means to purge liquid remaining in a delivery tube comprises a reservoir for pressurised gas, a gas supply duct leading from the reservoir to the delivery tube, and control means for supplying gas from the reservoir to the delivery tube after the end of a delivery operation.

9. A beverage dispensing system according to any preceding claim, wherein the dispensing system includes means to inject a carbonating gas into the delivery tube during delivery of a carbonated beverage or beverage component through the delivery tube.

10. A beverage dispensing system according to any preceding claim, wherein a flexible hose houses a plurality of delivery tubes each leading from a respective valve at the flow control location to a respective delivery spigot at the distal end of the flexible hose.

11. A beverage dispensing system according to any preceding claim, wherein the supply ducts are in an insulated sheath, and a beverage or beverage component is cooled and recirculated through the insulated sheath to cool the liquids in the supply ducts.

12. A beverage dispensing system according claim 11, wherein the beverage or beverage component recirculated through the insulated sheath is a carbonated liquid drawn from a container at the storage location.

13. A beverage dispensing system according to claim 11, wherein the beverage or beverage component recirculated through the insulated sheath is a still liquid.

14. A beverage dispensing system according to claim 13, wherein water is cooled and recirculated through the insulated sheath prior to being supplied to a dispensing tube.

15. A carbonated beverage dispensing installation comprising:
a reservoir for a carbonated beverage;
a supply duct for supplying the carbonated beverage from the reservoir to a delivery valve;
a delivery tube for conducting the carbonated beverage from the delivery valve to a delivery spigot in a delivery head; and
control means for selectively opening and closing the delivery valve;
and further comprising:
a reservoir for a carbonating gas;
a gas supply line for supplying carbonating gas from the reservoir to a gas control valve;
a gas injection line for supplying carbonating gas from the gas control valve to a gas injection port provided in the delivery tube downstream of the delivery valve;
and wherein the control means is adapted to open the gas control valve to deliver carbonating gas into the delivery tube while the delivery valve delivers carbonated beverage to the delivery tube.

16. A beverage dispensing installation according to claim 15, further comprising one or more further reservoirs adapted to contain non-carbonated beverage components, each having a respective further beverage component supply duct, delivery valve, delivery tube and spigot,
and wherein the control means is adapted to open the delivery valve for the carbonated beverage and a further delivery valve for a non-carbonated beverage component simultaneously.

17. A beverage dispensing installation according to claim 15 or claim 16, wherein the control means is operable to open the gas control valve for a predetermined period before opening of the delivery valve for the carbonated beverage.

18. A beverage dispensing installation according to any of claims 15 to 17, wherein the control means is operable to open and close the gas control valve cyclically during the period for which the delivery valve for the carbonated beverage is open.

19. A beverage dispensing installation according to any of claims 15 to 18, wherein the gas injection line extends through the wall of the delivery tube at a point immediately downstream of its dispensing valve, and extends in the downstream direction along the lumen of the beverage delivery tube, the gas injection line having gas injection openings spaced along that part of its length which is within the beverage delivery tube.

20. A method of dispensing a beverage, in which a carbonated beverage is selectively admitted to a delivery tube by opening and closing a delivery valve, and wherein a carbonating gas is introduced into the delivery tube while the delivery valve is open.

21. A method according to claim 20, wherein a gas control valve is opened to introduce carbonating gas into the delivery tube simultaneously with the opening of the delivery valve.

22. A method according to claim 21, wherein a gas control valve is opened to introduce carbonating gas into the delivery tube to pressurise the delivery tube shortly before the opening of the delivery valve.

23. A method according to claim 20, wherein a gas control valve is opened and closed cyclically to introduce carbonating gas into the delivery tube intermittently during the period for which the delivery valve is open.

24. A dispensing control arrangement for a beverage dispenser in which a carbonated beverage is supplied from a reservoir via a supply duct to a delivery valve, and wherein the beverage is conducted via a delivery tube from the delivery valve to a delivery spigot in a delivery head,
the beverage dispenser further comprising a reservoir for carbonating gas, a gas supply line for supplying gas from the reservoir to a gas control valve, and a gas injection line for supplying gas from the gas control valve to a gas injection port provided in the delivery tube downstream of the delivery valve;
and wherein the dispensing control arrangement comprises:
input means;
control means for selectively opening and closing the delivery valve and the gas control valve, the control means being adapted to open and close the delivery valve in response to signals from the input means, and to open the gas control valve while the delivery valve is open.

25. A dispensing control arrangement according to claim 24, wherein the input means is a control button having a “pressed” and a “released” condition, and wherein the control means causes the delivery valve to be open when the button is in the “pressed” condition, and closed when the button is in the “released” condition.

26. A dispensing control arrangement according to claim 24, wherein the input means is a control button having a pressed and a released condition, and wherein the control means causes the delivery valve to open for a predetermined time interval when the control button is moved from its released to its pressed condition.

27. A dispensing control arrangement according to claim 26, wherein the control means has an operating mode and a learning mode, and wherein in the learning mode the control means causes the delivery valve to be open when the button is pressed, and closed when the button is released, and the control means is adapted to store in a memory information relating to the length of time for which the delivery valve is open;
and wherein in the operating mode the control means causes the delivery valve to open for a length of time corresponding to the stored information when the control button is moved from its released to its pressed condition.

28. A beverage dispensing installation comprising:
a reservoir for a beverage or beverage component;
a supply duct for supplying the beverage or beverage component from the reservoir to a delivery valve;
a delivery tube for conducting the beverage or beverage component from the delivery valve to a delivery spigot in a delivery head; and
control means for selectively opening and closing the delivery valve;
and further comprising:
a reservoir for purging gas;
a gas supply line for supplying gas from the reservoir to a gas control valve;
a gas injection line for supplying gas from the gas control valve to a gas injection port provided in the delivery line downstream of the delivery valve;
and wherein the control means is adapted to open the gas control valve after the delivery valve is closed, for purging liquid from the delivery lines.

29. A beverage dispensing installation according to claim 28, wherein the control means is operable to open the gas control valve for a predetermined period after closure of the delivery valve.

30. A beverage dispensing installation according to claim 28 or claim 29, wherein the beverage dispensing installation comprises a plurality of beverage reservoirs, each having a respective beverage supply duct, delivery valve, delivery tube, gas injection line and spigot.

31. A beverage dispensing installation according to claim 30, wherein the control means is adapted to open one or more of the delivery valves simultaneously, to deliver a mixture of beverage components.

32. A beverage dispensing installation according to claim 30 or claim 31, wherein a single gas control valve provides gas to a plurality of gas injection lines each connected to a respective delivery tube, and the control means is adapted to open the gas control valve to admit gas to all of the delivery tubes after each beverage dispensing operation.

33. A beverage dispensing installation according to claim 30 or claim 31, wherein each gas injection line has a respective gas control valve, and the control means is adapted to open, after each dispensing operation, only the gas control valve which control gas injection to delivery tubes used in that dispensing operation.

34. A beverage dispensing installation according to any of claims 28 to 33, wherein a purging gas injection line extends through the wall of each respective delivery tube at a point immediately downstream of its dispensing valve, and extends in the downstream direction along the lumen of the beverage delivery tube, the gas injection line having gas injection openings spaced along that part of its length which is within the beverage delivery tube.

35. A beverage dispensing installation according to any of claims 28 to 34, wherein the beverage reservoirs and delivery valves are fixed in position, and the delivery tubes are housed within a pillar formed with a dispensing head at its upper end, the delivery spigots being housed in the dispensing head.

36. A beverage dispensing installation according to claim 35, wherein the pillar is adapted to be mounted to a fixed structure such as a counter.

37. A beverage dispensing installation according to any of claims 28 to 34, wherein the beverage reservoirs and delivery valves are fixed in position, and the delivery tubes are housed within a flexible sheath fixed at its proximal end and formed with a dispensing head at its distal end, the delivery spigots being housed in the dispensing head.

38. A beverage dispensing installation according to claim 37, as dependant on claim 34, wherein purging gas injection lines extend along the lumens of the beverage delivery tubes, within the flexible sheath.

39. A beverage dispensing installation according to any of claims 35 to 38, wherein control buttons are provided on the dispensing head to provide control inputs to the control means.

40. A beverage dispensing installation according to claim 39, wherein the control buttons are connected to the control means by wires extending within the flexible sheath.

41. A method of dispensing a beverage, in which a beverage component is selectively admitted to a delivery line by opening and closing a delivery valve, and wherein a purging gas is introduced into the delivery line after closure of the delivery valve to expel liquid from the delivery line.

42. A method according to claim 41, wherein a gas control valve is opened after the closure of the delivery valve for a predetermined time interval to introduce the purging gas into the delivery line.

43. A dispensing control arrangement for a beverage dispenser in which a beverage or beverage component is supplied from a reservoir via a supply duct to a delivery valve, and wherein the beverage or beverage component is conducted via a delivery line from the delivery valve to a delivery spigot in a delivery head,
the beverage dispenser further comprising a reservoir for a purging gas, a gas supply line for supplying gas from the reservoir to a gas control valve, and a gas injection line for supplying gas from the gas control valve to a gas injection port provided in the delivery line downstream of the delivery valve;
and wherein the dispensing control arrangement comprises input means;
control means for selectively opening and closing the delivery valve and the gas control valve, the control means being adapted to open and close the delivery valve in response to signals from the input means, and to open the gas control valve after the delivery valve is closed, for purging liquid from the delivery line.

44. A dispensing control arrangement according to claim 43, wherein the input means is a control button having a “pressed” and a “released” condition, and wherein the control means causes the delivery valve to be open when the button is pressed, and closed when the button is released.

45. A dispensing control arrangement according to claim 43, wherein the input means is a control button having a pressed and a released condition, and wherein the control means causes the delivery valve to open for a predetermined time interval when the control button is moved from its released to its pressed condition.

46. A dispensing control arrangement according to claim 45, wherein the control means has an operating mode and a learning mode, and wherein in the learning mode the control means causes the delivery valve to be open when the button is pressed, and closed when the button is released, and the control means is adapted to store in a memory information relating to the length of time for which the delivery valve is open;
and wherein in the operating mode the control means causes the delivery valve to open for a length of time corresponding to the stored information when the control button is moved from its released to its pressed condition.

47. A purging gas injection arrangement for a beverage dispenser in which a dispensing valve is operable to admit a beverage component to a delivery tube, wherein a purging gas injection line extends through the wall of the delivery tube at a point immediately downstream of the dispensing valve, and extends in the downstream direction along the lumen of the beverage delivery tube, the gas injection line having gas injection openings spaced along that part of its length which is within the beverage delivery tube.

48. A beverage dispensing system wherein a carbonator for producing carbonated water from a mains water supply and respective containers for storing one or more flavouring syrups are provided at a storage location, respective supply ducts are provided to lead the carbonated water and flavouring syrup from the storage location to a flow control location, and at least one delivery tube is provided to lead the carbonated water and the flavouring syrup from the flow control location to a dispenser head, respective delivery valves being provided at the flow control location to control the delivery of carbonated water and flavouring syrup to the or a delivery tube, and wherein still water from the mains water supply is cooled and recirculated through an insulated sheath containing the supply ducts to cool the liquids in the supply ducts.

49. A carbonated beverage dispensing installation comprising:
a carbonator for carbonating still water from a water supply;
one or more reservoirs for containing flavouring syrups;
a supply duct for supplying the carbonated water from the carbonator to a delivery valve;
respective supply ducts for supplying the flavouring syrups from the reservoirs to respective delivery valves;
at least one delivery tube for connecting the delivery valves to a delivery spigot in a delivery head; and
control means for selectively opening and closing the delivery valves;
and further comprising:
an insulated sheath containing the supply ducts;
cooling means to cool still water from the water supply;
a recirculation pump operable to circulate cooled still water from the water supply through a cooling duct within the insulated sheath; and
water supply means for supplying cooled still water from the cooling duct to the carbonator.

50. An installation according to claim 49, further comprising means for selectively delivering cooled still water from the cooling duct through a delivery valve to a delivery tube.
